(19) United States
(12) Patent Application Publication
(10) Pub. No.: US 2007/0014232 A1
(43) Pub. Date: Jan. 18, 2007

(54) Apparatus and method for detecting network failure

(75) Inventors: Takeshi Yasuie, Kawasaki (JP); Yuji Nomura, Kawasaki (JP)

Correspondence Address: BINGHAM MCCUTCHEN LLP, 3000 K STREET, NW, BOX IP, WASHINGTON, DC, 20007, US

(73) Assignee: FUJITSU LIMITED

(21) Appl. No.: 11/229,717

(22) Filed: Sep. 20, 2005

(30) Foreign Application Priority Data
Jun. 13, 2005 (JP) 2005-172638

(51) Int. Cl. H04L 12/26

(52) U.S. Cl. 370/216

(57) ABSTRACT

A network failure detection apparatus is realized as a function of a terminal in a network. The network failure detection apparatus transmits reachability confirmation packets to a terminal of search object. From a reachability condition decided on the basis of the receiving condition of response packets responding to the reachability confirmation packets, it is decided whether there is an L2 loop occurred on a path to the terminal of search object.

### CROSS-REFERENCE TO RELATED APPLICATIONS

This application is based upon and claims the benefit of priority from the prior Japanese Patent Application No. 2005-172638, filed on Jun. 13, 2005, the entire contents of which are incorporated herein by reference.

### BACKGROUND OF THE INVENTION

1. Field of the Invention

The present invention relates to a network failure detection apparatus and a network failure detection method for detecting a failure in a network, and more particularly a network failure detection apparatus and a network failure detection method for detecting a layer-2 loop, a failure which occurs in a relay unit constituting the network.

2. Description of the Related Art

The relay unit referred to as layer 2 (L2) switch, which constitutes a network such as LAN, is a kind of network relay unit, having a function of transferring packets after determining the destinations from data in the data link layer (the second layer) of the OSI reference model. The data link layer protocol includes MAC (media access control) in Ethernet, etc., and an Ethernet relay unit determining the destination of the data by referring to a MAC address is also referred to as switching hub. Since protocols such as IP, TCP and HTTP are placed in the network layer (the third layer) or higher, the layer 2 switch can transfer packets even when the protocols in the third layer or higher are different.

In a network in which a plurality of terminals are connected through the layer 2 switches, a failure called ‘layer 2 loop’ possibly occurs throughout the entire network area caused by an incorrect cable connection, a fault in the layer 2 switch, etc. The occurrence of the layer 2 loop produces high load conditions in the terminals throughout the entire network area, and brings about a disabled condition of network communication.

FIGS. 1 through 3 show explanation diagrams of the network failure caused by the layer 2 loop (hereafter referred to as ‘L2 loop’). In FIG. 1, the network has the following configuration: In subordination to a ‘layer 2 switch’ (hereafter simply referred to as ‘switch’) SW1, switches SW2, SW3 and SW4 are connected to the network. Further, switches SW5, SW6 and SW7 are connected subordinate to the switches SW2, SW3 and SW4, respectively. Terminals Y1, Y2 and X are then connected to the switches SW5, SW6 and SW7, respectively. In the above network configuration, it is assumed that a loop connection is formed in the switch SW2 due to incorrect cable connection in the switch SW2, resulting in the occurrence of an L2 loop at this point.

Now, an example such that the terminal X transmits a broadcast packet will be explained hereafter. When the broadcast packet is transmitted from the terminal X, the broadcast packet reaches the switch SW2, having the loop occurred therein, via the switches SW7, SW4 and SW1. Each time the broadcast packet is circulated in the loop occurred in the switch SW2, the broadcast packet is transmitted throughout the entire area of the network (subnetwork). Because such the loop circulation is performed at a wire speed, the result is that the broadcast packet is kept on transmitting throughout the entire network from the switch SW2 at wire speed (which is referred to as ‘broadcast storm’), and the terminals in the network fall into heavy load conditions.

Also, when the broadcast packet is input to one of the plurality of ports in each switch, the switch stores the MAC address of the originating terminal included in the broadcast packet. The switch then recognizes the direction, in which the originating terminal of the broadcast packet is existent, to be the direction of the input port in regard to the originating terminal of interest (hereafter, the above recognition may also be represented as ‘learning the address’). Accordingly, as a result of the above broadcast storm, there emerges a switch in which incorrect learning (hereafter referred to as ‘mislearning’) of the originating terminal address is made. Namely, because each switch recognizes the source address of the broadcast packet to be located in the direction of the point of the L2 loop occurrence (i.e. the switch SW2), the address mislearning of the originating terminal is brought about in the respective switches which are located on the path between the terminal X and the point of the L2 loop occurrence. More specifically, the address of the terminal X is learned as if the terminal X transmitting the broadcast packet exists in the switch SW2 in which the L2 loop is occurred, as a virtual image of the terminal X. Therefore, in the figure, the switches SW7, SW4, SW1 and SW2, which are located on the path between the terminal X and the point of the L2 loop occurrence, mislearn the address of the terminal X. As such, in a state of the L2 loop being occurred, when a broadcast packet is transmitted from a terminal, switches located on a path between the terminal concerned and the point of the occurrence of the L2 loop mislearn the terminal address concerned.

In regard to the switches SW3, SW5 and SW6, no such mislearning occurs, which is merely because a packet reception direction in case of a packet transmitted from the actual terminal X happens to coincide with a packet reception direction in case of a packet transmitted from the point of the L2 loop occurrence.

As described above, in the state of mislearning the address of the terminal X, the terminal Y1 transmits a unicast packet to the terminal X, as shown in FIG. 2. The unicast packet reaches the switch SW2 via the switch SW5. Since the switch SW2 has mislearned the address of the terminal X, the unicast packet is kept on circulating in the L2 loop occurred in the switch SW2. As a result, the unicast packet does not reach the terminal X, and the communication between the terminal Y1 and the terminal X becomes not possible. Also, the switch SW2 mislearns the address of the terminal Y1 as if the terminal Y1 is existent in the L2 loop. As such, when a unicast packet is transmitted to an address which has been mislearned so as to reach a point of occurrence of the L2 loop, in the switch SW2 having the L2 loop occurred therein, the address of the originating terminal of the unicast packet is mislearned to be located in the direction of the L2 loop. Here, another switch SW5 correctly learns the address of the terminal Y1.

Similarly, as shown in FIG. 3, in the state that the address of the terminal X is mislearned as described above, the terminal Y2 transmits a unicast packet to the terminal X. The unicast packet reaches the switch SW2 via the switches SW6, SW3 and SW1. The switch SW2 has mislearned the address of the terminal X, and the unicast packet is kept on circulating in the L2 loop occurred in the switch SW2. As a result, the unicast packet does not reach the terminal X, and the communication with the terminal X becomes not possible. Also, the switch SW2 mislearns the address of the terminal Y2, as if the terminal Y2 is existent in the L2 loop. Here, other switches SW6, SW3 and SW1 correctly learn the address of the terminal Y2.

As a technique for detecting such the L2 loop which causes a network failure, for example, in the official gazette of the Japanese Unexamined Patent Publication No. 2001-197114, an L2 loop detection method, in which an infinite loop is determined by analyzing a receiving frame, is disclosed.

When the L2 loop occurs, conventionally, localization of the occurred L2 loop point has been made by manually ejecting and inserting cables of the layer 2 switch, or by repeating an information acquisition procedure related to the connection condition of the switch being suspected of the failure. Accordingly, a substantially long time (a few hours to a few days) and a large amount of work have been required before finding out the L2 loop point.

Further, according to the technique disclosed in the above official gazette of the Japanese Unexamined Patent Publication No. 2001-197114, it is possible to detect the occurrence of the L2 loop somewhere in the network (subnetwork). However, it is not possible to identify an exact point of the L2 loop in the subnetwork.

### SUMMARY OF THE INVENTION

Accordingly, it is an object of the present invention to provide a network failure detection apparatus and a network failure detection method, capable of detecting the occurrence of an L2 loop and the point thereof easily and promptly.

As a first configuration of the network failure detection apparatus according to the present invention to achieve the above-mentioned object, the network failure detection apparatus, which is a first terminal among a plurality of terminals, detecting a failure in a network in which each terminal is connected to another terminal via at least one relay unit among a plurality of relay units. The network failure detection apparatus includes: a transmission section transmitting a reachability confirmation data to a second terminal among the plurality of terminals; a reception section receiving a response data from the second terminal in response to the reachability confirmation data; and, a decision section deciding whether a loop causing a predetermined network failure is occurred in a relay unit which is existent on the path to the second terminal, based on a receiving state of the response data.

As a second configuration of the network failure detection apparatus according to the present invention, in the above first configuration, the decision section decides whether or not there is reachability with the second terminal based on the receiving state of the response data. The decision section decides that the loop is occurred when deciding there is no reachability, and that the loop is not occurred when deciding there is reachability.

As a third configuration of the network failure detection apparatus according to the present invention, in the above second configuration, the decision section obtains a reachability rate, which is a ratio of the number of the response data being received to the number of the reachability confirmation data being transmitted, and decides that there is no reachability when the reachability rate is lower than a predetermined value, and decides that there is reachability when the reachability rate is the predetermined value or higher.

As a fourth configuration of the network failure detection apparatus according to the present invention, in the above first configuration, when the number of the response data being received exceeds the number of the reachability confirmation data being transmitted, the decision step decides the loop is occurred.

As a fifth configuration of the network failure detection apparatus according to the present invention, in the above first configuration, the network failure detection apparatus further includes a communication restoration processor performing broadcast transmission of a plurality of data each having a source address excluding the second terminal address and the address of the network failure detection apparatus. The above-mentioned communication restoration processor performs broadcast transmission of the plurality of data before the transmission section transmits the reachability confirmation data to the second terminal.

As a sixth configuration of the network failure detection apparatus according to the present invention, in the above fifth configuration, the network failure detection apparatus further includes a monitoring section detecting reception of a broadcast data having, as source address, either the address of the network failure detection apparatus or the second terminal address, while the transmission section transmits the reachability confirmation data and the reception section receives the response data. When the monitoring section detects reception of the broadcast data, the communication restoration processor performs broadcast transmission of the plurality of data again, and the transmission section transmits the reachability confirmation data, and the decision section decides whether or not the loop is occurred, based on the receiving state of the response data in the reception section.

As a seventh configuration of the network failure detection apparatus according to the present invention, in the above first configuration, the network failure detection apparatus further includes a load reduction processor performing broadcast transmission of a plurality of data having data lengths longer than the data length of the data circulating in the loop at the time of the occurrence of the loop. The load reduction processor performs broadcast transmission of the plurality of data before the transmission section transmits the reachability confirmation data to the second terminal.

As an eighth configuration of the network failure detection apparatus according to the present invention, in the above fifth configuration, the plurality of data have longer data lengths than the data length of the data circulating in the loop at the time of the occurrence of the loop.

As a ninth configuration of the network failure detection apparatus according to the present invention, in the above first configuration, the reachability confirmation data is an ARP data, which is transmitted to the second terminal in a unicast form.

As a tenth configuration of the network failure detection apparatus according to the present invention, in the above first configuration, the reachability confirmation data is a Ping data, which is transmitted to the second terminal in a unicast form.

As an eleventh configuration of the network failure detection apparatus according to the present invention, in the above first configuration, the network failure is a layer 2 loop failure, in which the data circulating in the loop are continuously transmitted in a broadcast form from the loop.

According to the present invention, as a first network failure detection method being performed in a first terminal among a plurality of terminals, for detecting a failure in a network in which each terminal is connected to another terminal via at least one relay unit among a plurality of relay units. The network failure detection method includes: a transmission step for transmitting a reachability confirmation data to a second terminal among the plurality of terminals; a reception step for receiving a response data from the second terminal in response to the reachability confirmation data; and a decision step for deciding whether a loop causing a predetermined network failure is occurred in a relay unit which is existent on the path to the second terminal based on a receiving state of the response data.

As a second network failure detection method according to the present invention, in the above first network failure detection method, the decision step decides whether or not there is reachability with the second terminal is existent, based on the receiving state of the response data, and decides that the loop is occurred when deciding there is no reachability, and that the loop is not occurred when deciding there is reachability.

As a third network failure detection method according to the present invention, in the above second network failure detection method, the decision step obtains a reachability rate, which is a ratio of the number of the response data being received to the number of the reachability confirmation data being transmitted, and decides that there is no reachability when the reachability rate is lower than a predetermined value, and decides that there is reachability when the reachability rate is the predetermined value or higher.

As a fourth network failure detection method according to the present invention, in the above first network failure detection method, when the number of the response data being received exceeds the number of the reachability confirmation data being transmitted, the decision step decides the loop is occurred.

As a fifth network failure detection method according to the present invention in the above first network failure detection method, prior to the transmission step, the method includes a communication restoration step for performing broadcast transmission of a plurality of data each having a source address excluding the second terminal address and the address of the network failure detection apparatus.

As a sixth network failure detection method according to the present invention, in the above fifth network failure detection method, during the reception step, the method includes a reception monitoring step for detecting reception of a broadcast data having, as source address, either the address of the network failure detection apparatus or the second terminal address, and when the reception monitoring step detects reception of the broadcast data, the transmission step, the reception step and the decision step are repeated again.

As a seventh network failure detection method according to the present invention, in the above first network failure detection method, prior to the transmission step, the method includes a load reduction step for performing broadcast transmission of a plurality of data having data lengths longer than the data length of the data circulating in the loop at the time of the occurrence of the loop.

As an eighth network failure detection method according to the present invention, in the above fifth network failure detection method, the plurality of data have data lengths longer than the data length of the data circulating in the loop at the time of the occurrence of the loop.

As a ninth network failure detection method according to the present invention, in the above first network failure detection method, the network failure is a layer 2 loop failure, in which the data circulating in the loop are continuously transmitted in a broadcast form from the loop.

According to the present invention, it is possible to detect occurrence of a loop causing a trouble in a network, and a point of occurrence as well.

Further, the loop can be detected through the processing in the terminal constituting the network, without requiring processing in relay equipment constituting the network. Namely, although implementation of a new function in the relay equipment requires a relatively large amount of work and time, the present invention does not require such implementation. Only the application program enabling the processing according to the present invention is to be installed in the terminal. Through the execution of the above processing, the present invention can be implemented in an easy and simple manner for wide use.

Further scopes and features of the present invention will become more apparent by the following description of the embodiments with the accompanied drawings.

### BRIEF DESCRIPTION OF THE DRAWINGS

FIG. 1 shows an explanation diagram of the network failure caused by a layer 2 loop.

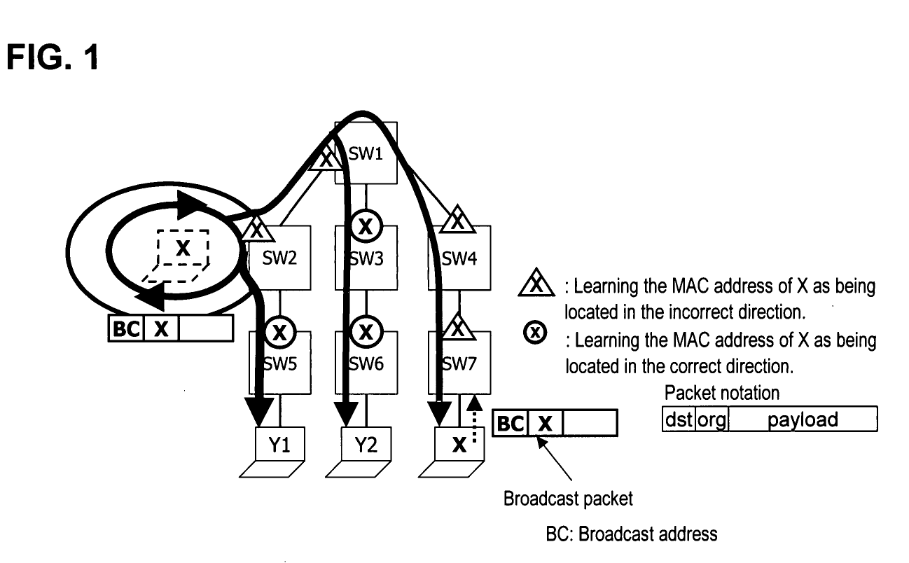

FIG. 2 shows an explanation diagram of the network failure caused by a layer 2 loop.

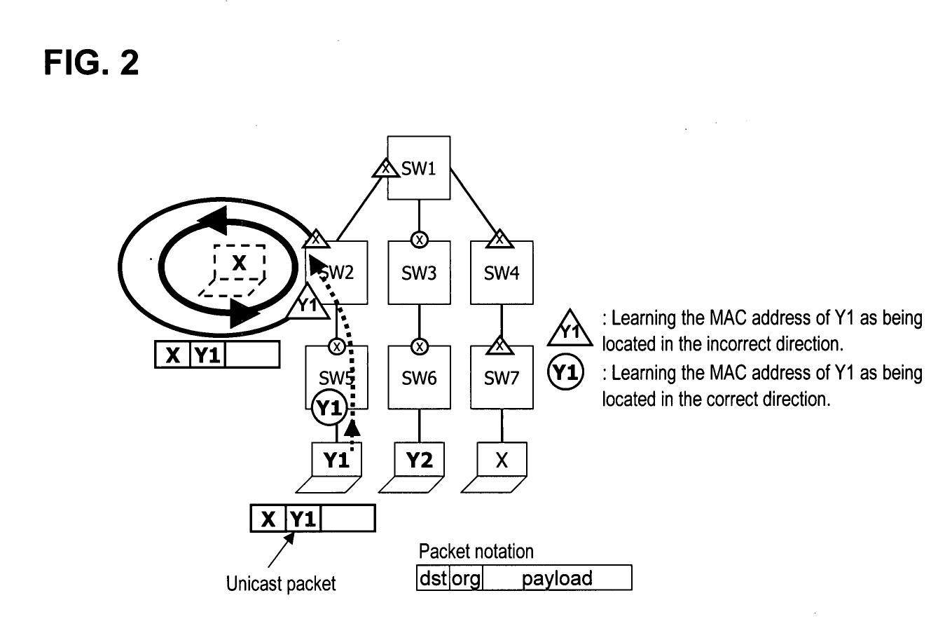

FIG. 3 shows an explanation diagram of the network failure caused by a layer 2 loop.

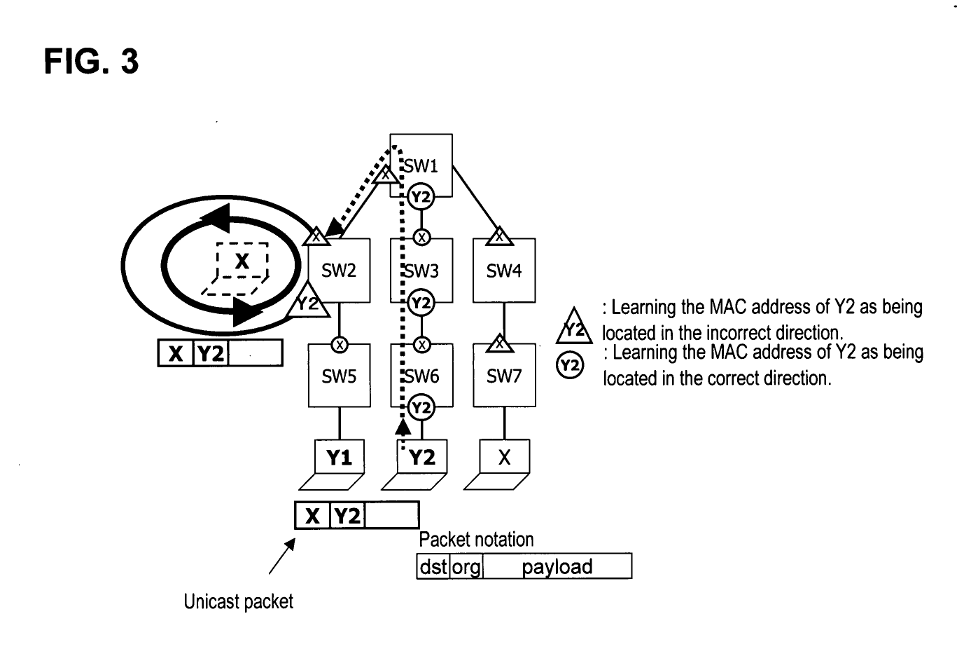

FIG. 4 shows a principle configuration diagram of a network failure detection apparatus according to an embodiment of the present invention.

FIG. 5 shows a general processing flowchart of a network failure detection apparatus according to an embodiment of the present invention.

FIG. 6 shows a processing flowchart of a network failure detection apparatus according to a first example of the embodiment of the present invention.

FIG. 7 shows an explanation diagram of the processing of a first example of the embodiment of the present invention.

FIG. 8 shows an explanation diagram of the processing of a first example of the embodiment of the present invention.

FIG. 9 shows a reachability confirmation process flowchart in a network failure detection apparatus according to a second example of the embodiment of the present invention.

FIG. 10 shows an explanation diagram of a second example of the embodiment of the present invention (in case of duplicated reception).

FIG. 11 shows a first processing flowchart for acquiring the MAC address of a terminal of search object.

FIG. 12 shows a second processing flowchart for acquiring the MAC address of a terminal of search object.

FIG. 13 shows a processing flowchart in case of monitoring the source address of a broadcast packet during reachability confirmation processing.

### DETAILED DESCRIPTION OF THE INVENTION

The preferred embodiment of the present invention is described hereinafter referring to the charts and drawings. However, it is noted that the technical scope of the present invention is not limited to the embodiments described below.

A network failure detection apparatus in accordance with an exemplary embodiment of the present invention is realized as one function of a terminal in a network. The network failure detection apparatus transmits a reachability confirmation packet to a terminal of search object, and decides whether a layer 2 loop is existent on a path to the terminal of the search object, by deciding whether or not there is reachability based on the reception condition of a response packet to the above reachability confirmation packet.

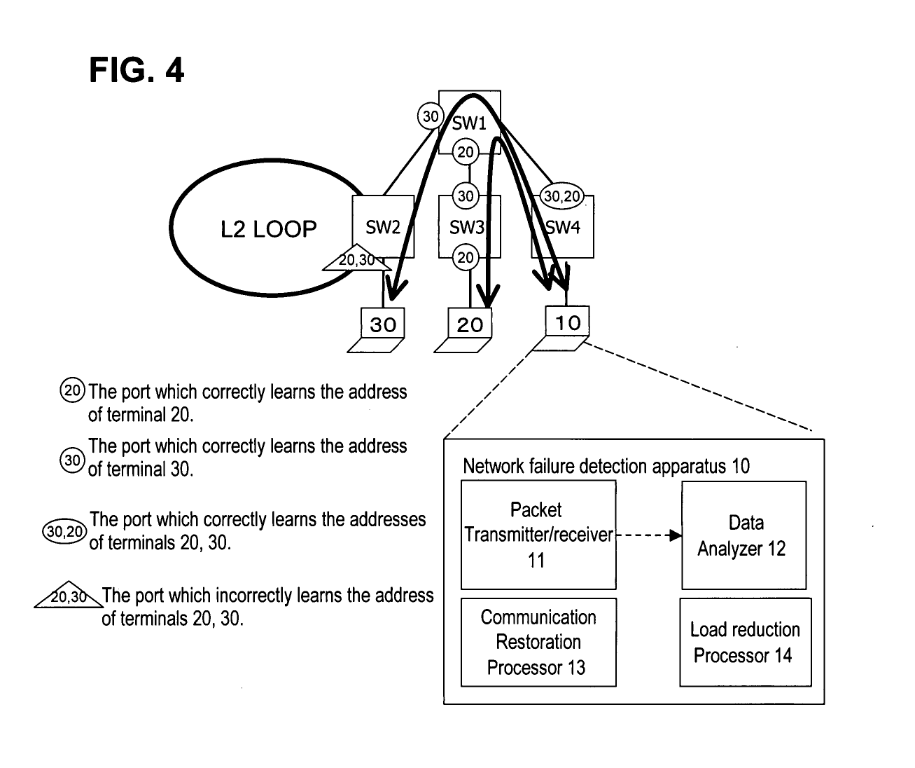

FIG. 4 shows a principle configuration diagram of a network failure detection apparatus according to an embodiment of the present invention. In FIG. 4, a network is structured of switches SW2, SW3 and SW4 which are connected in subordination to a layer 2 switch SW1, and terminals 10, 20 and 30 connected to the respective switches SW2, SW3 and SW4. Terminal 10 is a network failure detection apparatus, which includes a packet transmitter/receiver 11, a data analyzer 12, a communication restoration processor 13 and a load reduction processor 14, as functions of the network failure detection apparatus. The processing performed in communication restoration processor 13 and load reduction processor 14 will be described later. Terminals 20, 30 are terminals of search objects, and whether or not an L2 loop is existent on a path between terminal 10 and terminal 20, or between terminal 10 and terminal 30, is searched. In the example shown in FIG. 4, the L2 loop occurs at the switch SW2. Due to the occurrence of the L2 loop, the switch SW2 mislearns the MAC addresses of terminals 20, 30 of search objects. Meanwhile, the switches other than the switch SW2, namely the switches SW1, SW3 and SW4, correctly learn the MAC addresses of terminals 20, 30 of search objects.

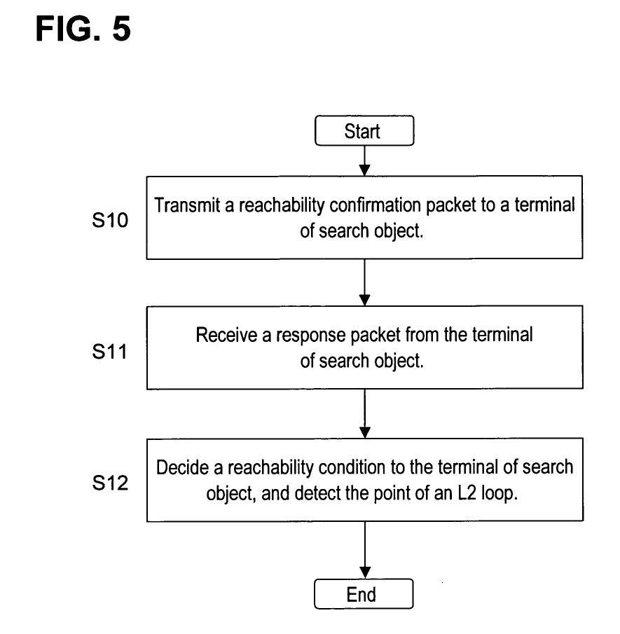

FIG. 5 shows a general processing flowchart of the network failure detection apparatus according to the embodiment of the present invention. Packet transmitter/receiver 11 transmits a reachability confirmation packet to the terminals of search objects (S10), and receives a response packet thereof (S11). Here, in the present specification, the term ‘reception’ includes reception of zero response packet, i.e. no reception of a response packet. Data analyzer 12 decides reachability conditions to the terminals of search objects based on the receiving conditions of the response packets, and detects the point of the L2 loop (S12). The reachability confirmation packet is, for example, an ARP (Address Resolution Protocol) packet, or a Ping (Packet INternet Groper) packet of unicast type. Hereafter, the embodiments of the present invention will be described in detail.

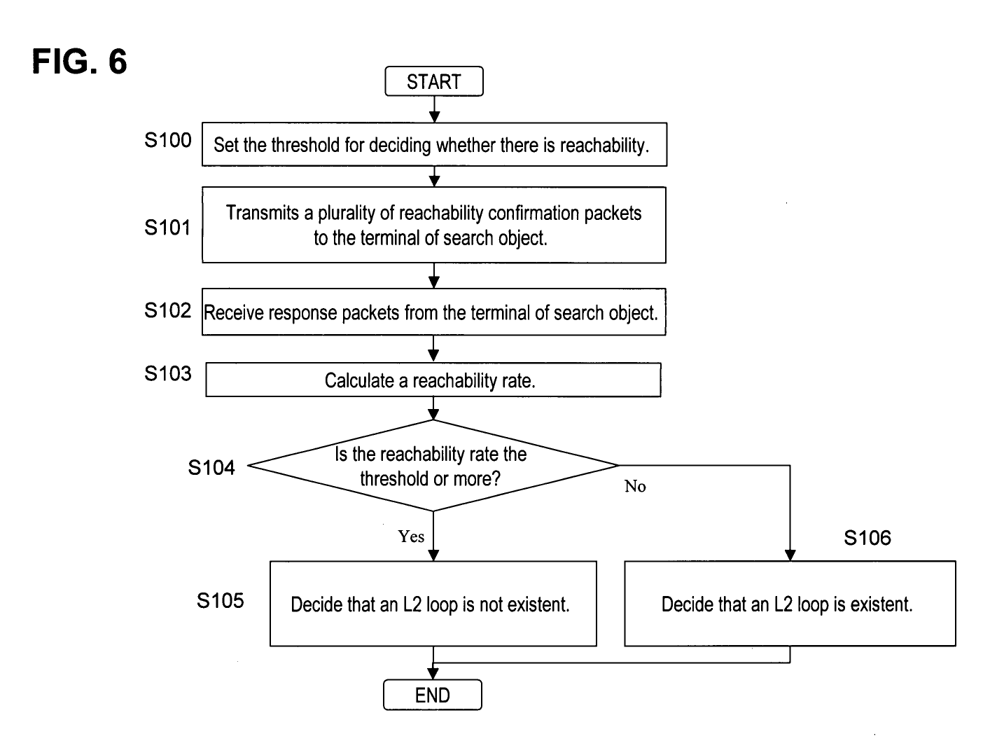

FIG. 6 shows a flowchart of reachability confirmation processing according to a first exemplary embodiment of the present invention. In this first embodiment, it is decided whether or not there is reachability based on a reachability rate, which is a ratio of the number of response packets being receiving to the number of reachability confirmation packets being transmitted. Thus, the occurrence of the L2 loop and the point of occurrence of the L2 loop are detected.

In step S100, a threshold of the reachability rate for deciding whether or not there is reachability can be existent is set in advance. The threshold is, for example, 95%. Theoretically, when there is reachability, the same number of response packets as the number of reachability confirmation packets is to be returned. However, it is preferable to set the threshold slightly smaller than 100%, assuming a case such that an extremely small number of reachability confirmation packets or response packets do not reach the destinations.

Packet transmitter/receiver 11 transmits a plurality of reachability confirmation packets (the number of packets is predetermined to be, for example, 100) to terminals of search objects (S101). If the reachability confirmation packets reach the terminals of search objects correctly, the terminals of search objects transmit reception packets in response to the reachability confirmation packets. Packet transmitter/receiver 11 receives the reception packets for a predetermined time from the transmission of the reachability confirmation packets (S102), and counts the number of the received response packets.

Data analyzer 12 calculates a reachability rate based on the number of response packets received in packet transmitter/receiver 11 (S103). In step S104, in case the reachability rate is no smaller than the threshold, it is decided that there is reachability with the terminal of search object, and that a loop is not occurred in the switch located on the path to the terminal of search object (S105) Meanwhile, in case that the reachability rate is smaller than the threshold, it is decided that there is no reachability to the terminal of search object, and that a loop is occurred in the switch located on the path to the terminal of source object (S106).

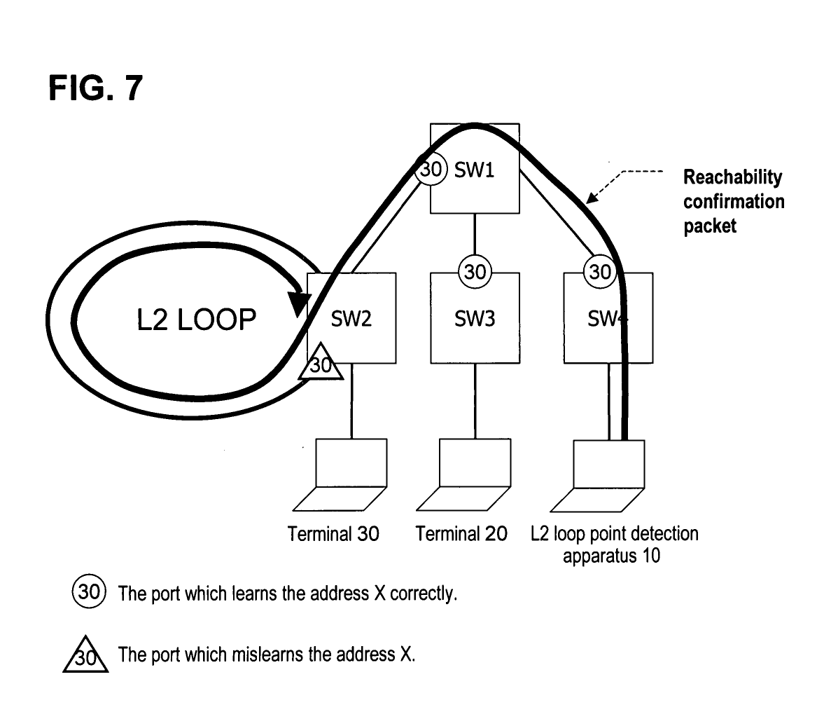

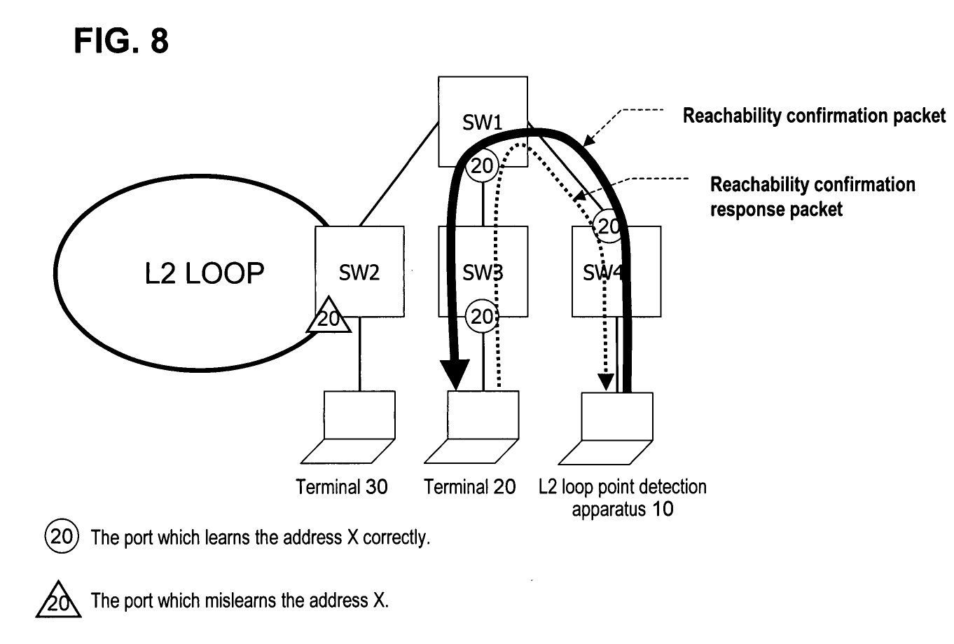

FIGS. 7 and 8 show explanation diagrams of the processing of a first example of the embodiment of the present invention. FIG. 7 shows an exemplary case of transmitting a reachability confirmation packet from network failure detection apparatus 10 to terminal 30, while FIG. 8 shows an exemplary case of transmitting a reachability confirmation packet from network failure detection apparatus 10 to terminal 20.

In FIG. 7, the reachability confirmation packet is transmitted from network failure detection apparatus 10 toward terminal 30. The reachability confirmation packet reaches the switch SW2 via the switches SW4, SW1. In this example, an L2 loop is not occurred in the switches SW4, SW1, in which the MAC address of terminal 30 is learned correctly. Therefore, at the stage of the reachability confirmation packet passing through the switches SW4, SW1, the reachability confirmation packet is correctly transmitted toward terminal 30, and reaches the switch SW2. In the switch SW2, an L2 loop is occurred, by which the switch SW2 mislearns the MAC address of terminal 30 of search object as being located in the direction of an output port of the L2 loop. As a result, the reachability confirmation packet is circulated in the L2 loop. Accordingly, the reachability confirmation packet does not reach terminal 30, and terminal 30 does not transmit a response packet. Thus, network failure detection apparatus 10 does not receive the response packet from terminal 30 also. When network failure detection apparatus 10 does not receive any response packet from terminal 30 even when a predetermined time elapses after transmitting the reachability confirmation packet, network failure detection apparatus 10 calculates that the reachability rate is 0%. Since the calculated reachability rate is smaller than the threshold (95%), network failure detection apparatus 10 decides a point of loop occurrence is existent on the path to terminal 30. Namely, it is decided that the L2 loop is occurred in any of the switches SW4, SW1 and SW2.

Subsequently, in FIG. 8, a reachability confirmation packet is transmitted from network failure detection apparatus 10 toward terminal 20. The reachability confirmation packet reaches terminal 20 via the switches SW4, SW1 and SW3. An L2 loop is not occurred in the switches SW4, SW1 and SW3, in which the MAC address of terminal 20 is learned correctly. Therefore, the reachability confirmation packet correctly reaches terminal 20, and is received therein. Terminal 20 transmits a response packet for responding to the reachability confirmation packet toward the network failure detection apparatus. The response packet reaches network failure detection apparatus 10 via the switches SW3, SW1 and SW4, and the response packet is received in network failure detection apparatus 10. In the case that a hundred (100) reachability confirmation packets are transmitted, and when 99 response packets return, network failure detection apparatus 10 calculates the reachability rate is 99%. Since the calculated reachability rate is not smaller than the threshold (95%), it is decided that there is no point of loop occurrence on the path to terminal 20. Thus, it is decided that no L2 loop is occurred in any switches SW4, SW1 and SW3.

From the above processing for terminal 30 shown in FIG. 7, it is found out that the L2 loop occurs in any one of the switches SW4, SW1 and SW2. Also, from the above processing for terminal 20 shown in FIG. 8, it is found out that no L2 loop occurs in any switches SW4, SW1 and SW3. From the above two processing results, it is decided the L2 loop occurs in the switch SW2.

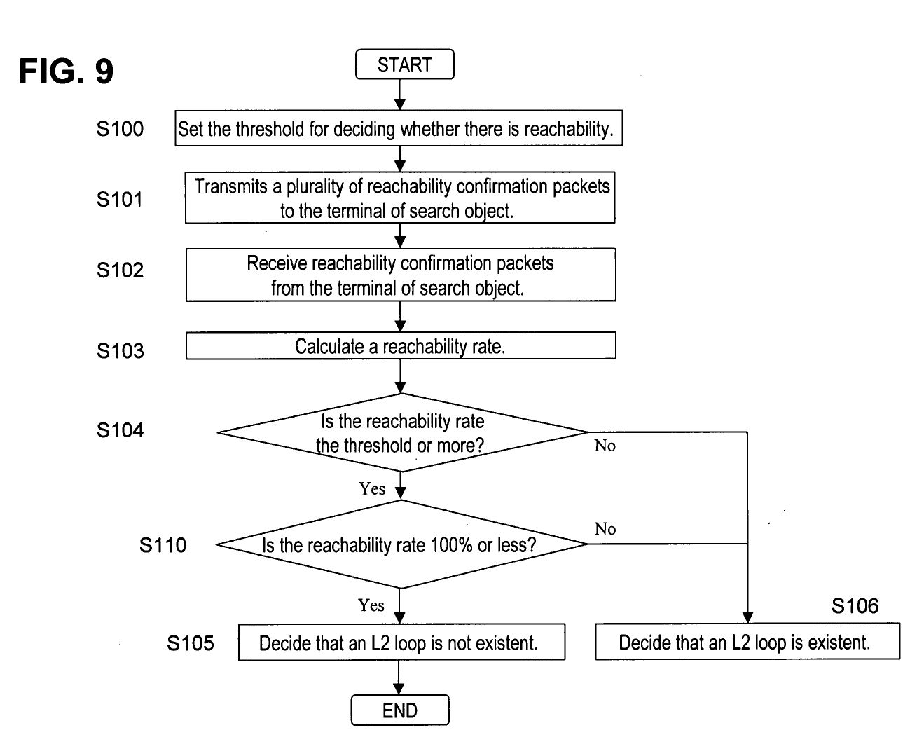

FIG. 9 shows a reachability confirmation process flowchart in a network failure detection apparatus according to a second example of the embodiment of the present invention. In this second exemplary embodiment, when the reachability rate is not smaller than the threshold in the first exemplary embodiment, further, it is decided whether or not the reachability rate exceeds 100%. In the case that the reachability rate exceeds 100%, it is decided there is a point of occurrence of the L2 loop. For example, when a hundred (100) reachability confirmation packets are transmitted toward a terminal of search object, and 105 response packets are received corresponding to the reachability confirmation packets, it is decided that there is an L2 loop on the path to the terminal of search object.

The switch having the L2 loop occurred therein mislearns the address of the terminal of search object. However, there may be a case that the switch operation temporarily falls into an unstable condition, which may cause a temporary loss of the address of the terminal of search object having been stored in the switch concerned, or a temporal change of the address of the terminal of search object. When the address is lost temporarily, the reachability confirmation packet reaches the terminal of search object, because the switch performs broadcast transmission of the received reachability confirmation packet. Further, the broadcast transmission causes the reachability confirmation packet transmitted to the L2 loop. By this, the reachability confirmation packet falls into circulation. Further, due to the temporal change of the address, if the address of the terminal of search object is changed from an output port to the L2 loop to the correct output port, there may arise a case that the reachability confirmation packet having been circulated in the L2 loop reaches the terminal of search object. As such, assume that the address having been learned is lost temporarily, bringing the reachability confirmation packet into broadcast transmission, and further the address is changed, causing the reachability confirmation packet circulating in the L2 loop to reach the terminal of search object. Then, the terminal of search object receives a greater number of reachability confirmation packets than the number of reachability confirmation packets transmitted from the network failure detection apparatus. Thereafter, when the response packets corresponding to the above received reachability confirmation packets reach the network failure detection apparatus, the network failure detection apparatus receives the response packets, of which number exceeds the transmitted number of the reachability confirmation packets (which is called duplicated reception). As described above, such the duplicated reception occurs when the L2 loop is occurred. Accordingly, on deciding the occurrence of the duplicated reception, the network failure detection apparatus decides that an L2 loop is occurred on the path to the terminal of search object.

In regard to FIG. 9, a process added to the process of the first embodiment shown in FIG. 6 is described.

Data analyzer 12 calculates a reachability rate based on the number of response packets received in packet transmitter/receiver 11 (S103), and in step S104, when the reachability rate is no smaller than the threshold, it is decided whether the reachability rate is no greater than 100% (S110). When the reachability rate is decided no greater than 100%, it is decided that there is reachability to the terminal of search object, and no loop is occurred in the switch located on the path to the terminal of search object (S105). Meanwhile, in case that the reachability rate exceeds 100%, i.e. the case of duplicated reception, it is decided there is no reachability to the terminal of search object, and a loop is occurred in the switch located on the path to the terminal of search object (S106). Needless to say, also when the reachability rate is smaller than the threshold, it is decided that there is no reachability to the terminal of search object, and that a loop is occurred in the switch located on the path to the terminal of search object (S106). It is also possible to decide the occurrence of the L2 loop directly when the number of received packets is greater than the number of transmitted packets, regardless of the calculation of the reachability rate.

The threshold is not limited to the reachability rate. It may also be possible to use the number of received response packets as threshold. For example, when transmitting 100 reachability confirmation packets, 95, the number of received response packets, is set as threshold.

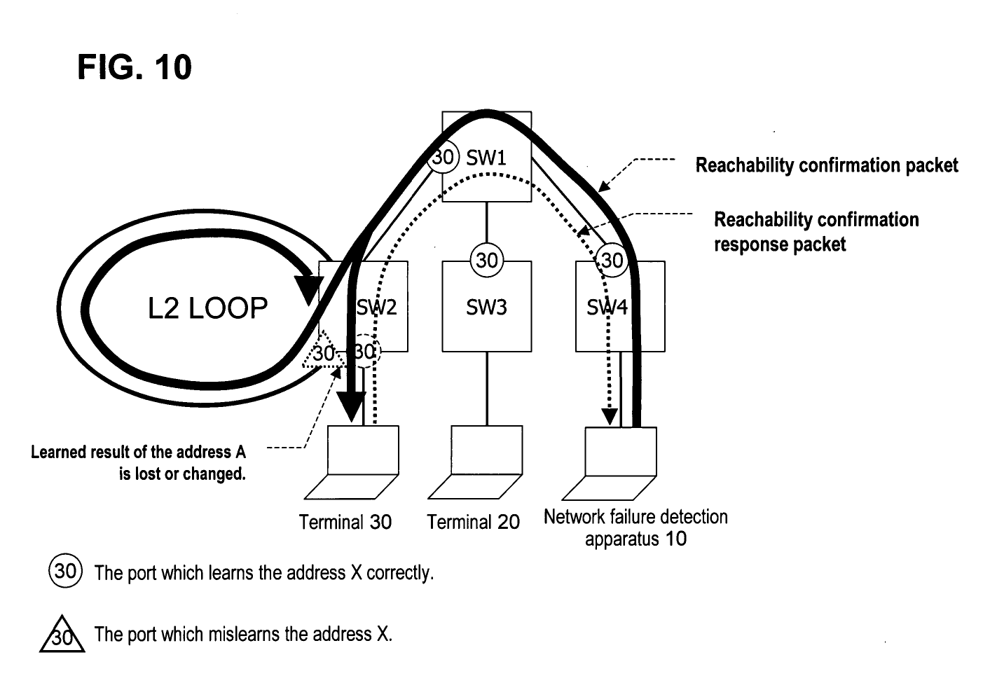

FIG. 10 shows an explanation diagram of a second example of the embodiment of the present invention (in case of the duplicated reception). A reachability confirmation packet is transmitted from network failure detection apparatus 10 toward terminal 30. The reachability confirmation packet reaches the switch SW2, in which an L2 loop is occurred, via the switches SW4, SW1. In the switch SW2, the address of terminal 30 temporarily is lost, or a temporal change occurs in regard to the address of terminal 30. Accordingly, as well as the reachability confirmation packet reaches terminal 30, the reachability confirmation packet having been circulated in the L2 loop due to the broadcast transmission also reaches terminal 30. As a result, terminal 30 receives the reachability confirmation packets of more than the number of reachability confirmation packets having been transmitted. Terminal 30 then transmits a response packet to each received reachability confirmation packet toward network failure detection apparatus 10. On receipt of the response packets of more than the number of reachability confirmation packets having been transmitted, network failure detection apparatus 10 decides there is a point of loop occurrence on the path to terminal 30. Namely, it is decided that the L2 loop is occurred in any switch SW4, SW1 or SW2.

As the reachability confirmation packet transmitted from the network failure detection apparatus, for example, a Ping (Packet INternet Groper) packet or an ARP (Address Resolution Protocol) packet may be used. The Ping packet is provided for diagnosing the network layer (the third layer) of the OSI reference model, which is transmitted by specifying the IP address of the terminal of diagnosis object. The network layer is diagnosed based on whether the response returns from the terminal, as well as the time consumed before the arrival of a response. By transmitting the Ping packet to the terminal of search object, specifying the IP address of the terminal of search object, it becomes possible to use the Ping packet for the reachability confirmation packet in the present invention. Also, the ARP packet is a packet for acquiring a MAC address of the data link layer (the second layer). In general, by specifying an IP address, and performing broadcast transmission by specifying the MAC address as the broadcast address, the terminal having the IP address responds with the self-MAC address. Through the unicast transmission of the ARP packet to the terminal of search object by specifying the IP address and the MAC address of the terminal of search object, the ARP packet can be used for the reachability confirmation packet in the present invention. Needless to say, a reachability confirmation packet exclusively used for the present invention may be generated.

Further, in order to transmit the reachability confirmation packet to the terminal of search object, it is necessary to acquire the MAC address of the terminal of search object, before performing processing in the embodiment of the present invention.

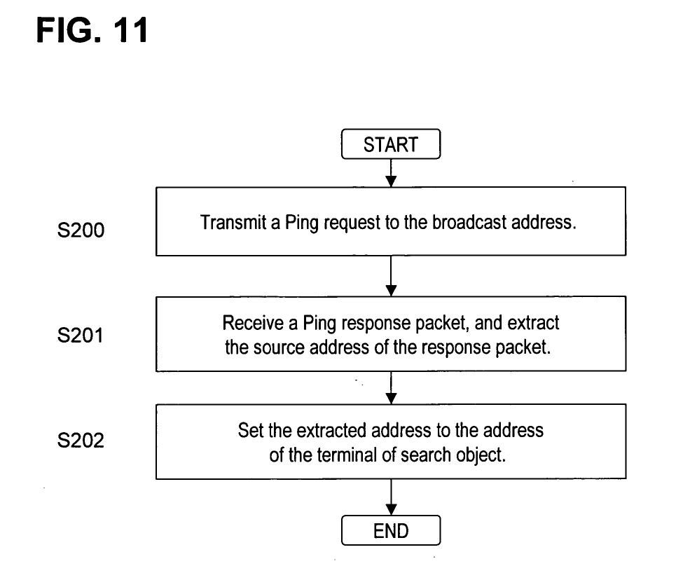

FIG. 11 shows a first processing flowchart for acquiring the MAC address of the terminal of search object. For example, when performing broadcast transmission of the above-mentioned Ping packet (S200), each terminal receiving the above packet returns a Ping response including the self-MAC address. On receipt of the response, the MAC address of the source terminal of the response packet is extracted from the received response (S201). With this, it becomes possible to acquire the address of each terminal. The extracted address is set to be the address of the terminal of search object (S202). When an L2 loop occurs, the responses do not made from the entire terminals in the network (subnetwork) for responding to the broadcast transmission of the Ping packet. Therefore, preferably, the MAC address acquisition is performed, for example, when it is obvious that communication in the network is normally performed (when obviously an L2 loop is not occurred). However, the L2 loop detection processing according to the embodiment of the present invention can be performed even when the MAC addresses of the entire terminals cannot be acquired. Therefore, it is not always necessary to have the responses from the entire terminals.

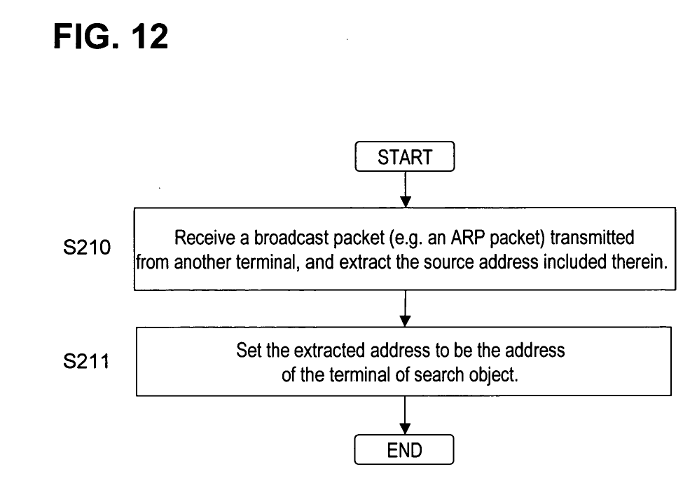

FIG. 12 shows a second processing flowchart for acquiring the MAC address of the terminal of search object. As another method for acquiring the MAC address, by receiving a broadcast packet (for example, ARP packet) transmitted from another terminal, and extracting the MAC address included in the received packet (S210), it is also possible to acquire the MAC address of a terminal existent in the subnetwork. The extracted address is set to be the address of the terminal of search object (S211).

Now, as explained in the description of the related art, when a broadcast packet is transmitted from a terminal in a state of an L2 loop being occurred, the switches located on the path from the terminal concerned to the point of the occurrence of the L2 loop mislearn the address of the terminal concerned. Accordingly, for example, in a state that the L2 loop is occurred in the switch SW2, when any broadcast packet is transmitted from terminal 20, the address of terminal 20 is also mislearned as if the address of terminal 20 is located in the L2 loop direction. Then, when a reachability confirmation packet is transmitted from network failure detection apparatus 10 to terminal 20, the reachability confirmation packet incorrectly reaches the switch SW2. As a result, whereas any switch having an L2 loop does not exist on the path to the actually existing terminal 20, there may occur a situation that the reachability confirmation packet does not reach the switch SW2. Since terminal 20 does net transmit a response packet responding to the reachability confirmation packet needless to say, there is a risk that network failure detection apparatus 10 incorrectly detects the occurrence of an L2 loop on the path to terminal 20 also.

Accordingly, in the embodiment of the present invention, a measure is adopted to avoid such an inconvenient situation that a reachability confirmation packet does not reach a terminal of search object whereas there is no switch having the L2 loop occurred on the path between the network failure detection apparatus and the terminal of search object concerned. Namely, communication restoration processor 13 performs processing for restoring in advance communication to the terminal of search object having no switch of L2 loop occurred on the path to the network failure detection apparatus.

Communication restoration processor 13 provided in the network failure detection apparatus continuously transmits a plurality of broadcast packets (hereafter referred to as dummy packets) having a source address of MAC address other than the MAC address of the terminal of search object. When a dummy packet is transmitted in a broadcast form, the dummy packet reaches the L2 loop, and starts to circulate. Since broadcast packets having already been circulated are input to the input port of the switch SW2 having the L2 loop occurred therein, as well as the above input dummy packet, a state of one-output and two-inputs arises. If the dummy packets are transmitted continuously and in large quantities, the length of an output queue or an input queue exceeds a tolerable value, causing the packets to be discarded. When the dummy packets are kept on transmitting further, a broadcast packet having the terminal of search object as source is successively replaced by the dummy packet. Finally, the broadcast packets each having the terminal of search object as source are entirely replaced by the dummy packets. This causes that the broadcast packets, each having the terminal of search object as source, are not transmitted any more from the L2 loop. Further, when the broadcast packet is such a broadcast packet that requests the terminal of search object to respond with a unicast packet, the mislearned addresses of the terminal of search object are cancelled in the entire switches of the network. Thus, communication to the terminal of search object can be restored.

Also, there is a case that the network failure detection apparatus itself transmits broadcast packets in the situation that the L2 loop is occurred. In such a case, the address of the network failure detection apparatus is also mislearned in the switches of the network. As a result, in the reachability confirmation processing, even though a reachability confirmation packet reaches the terminal of search object, the response packet responding thereto does not reach the network failure detection apparatus, because the response packet enters into an L2 loop. Since network failure detection apparatus 10 does not receive the response packet, there is a risk of incorrect detection of an L2 loop in the network failure detection apparatus 10, as if the L2 loop is occurred on the path to the terminal of search object. Therefore, it is also necessary to perform communication restoration processing using dummy packets each having, as source address, a MAC address other than the MAC address of the network failure detection apparatus.

It is sufficient that the source address of the dummy packet is a MAC address other than the MAC address of the terminal of search object, which may be a nonexistent virtual address or a MAC address of another existent terminal. However, in case of communicating with the above existing terminal, it becomes necessary to perform communication restoration processing again.

After performing the communication restoration processing, the network failure detection apparatus transmits a reachability confirmation packet to the terminal of search object, and performs the above-mentioned reachability confirmation processing for deciding whether or not the L2 loop is existent.

Further, after the aforementioned communication restoration processing, and during the reachability confirmation processing, the terminal of search object or the network failure detection apparatus may possibly transmit a broadcast packet, which is initiated by the execution of other processing performed in parallel with the reachability confirmation packet. Due to the broadcast packet being transmitted during the reachability confirmation processing, there is a risk that the address of the terminal of search object or the network failure detection apparatus is mislearned again. As a result, an L2 loop is incorrectly detected on the path having no L2 loop. To cope with the above problem, preferably, in the reachability confirmation processing, the network failure detection apparatus monitors the source address of the broadcast packet being received.

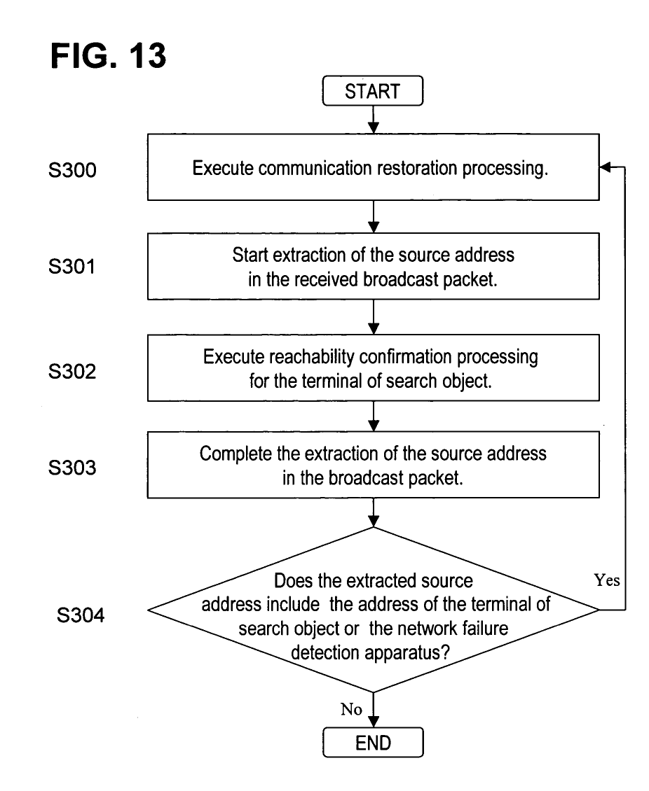

FIG. 13 shows a processing flowchart in case of monitoring the source address of a broadcast packet during the reachability confirmation processing.

Communication restoration processing 13 performs communication restoration processing (S300), and secures reachability to the terminal of search object. Extraction of the source address in the received broadcast packet is started (S301). Reachability confirmation processing to the terminal of search object is performed (S302). When the reachability confirmation processing is completed, the extraction of the source address in the received broadcast packet is completed (S303). In step S304, in the case that the received broadcast packet includes the address of the network failure detection apparatus itself and the address of the terminal of search object, the process returns to step S300, so as to start the processing afresh. In the case the received broadcast packet does not include the address of the network failure detection apparatus itself and the address of the terminal of search object, the process is completed because the reachability confirmation processing is completed correctly.

Also, as explained in the description of the related art, on the occurrence of the L2 loop, there occurs a broadcast storm phenomenon, in which transmission of broadcast packets continues from the switch having the occurrence of the L2 loop, which causes the entire terminals in the network to fall into heavy load conditions. When the reachability confirmation processing in accordance with the present embodiment is performed in the heavy load conditions, the processing speeds in the network failure detection apparatus and the terminal of search object are decreased, causing processing delay, or the processing is halted, and also possibly the packet transmission speed is decreased.

Since the reception of the broadcast packets produces interruption processing in the terminals and switches of the network, the CPU occupancies thereof become heavy load conditions. This may cause a serious trouble such that no other processing cannot be performed, or the processing speed is decreased. In particular, like the ARP packet, a broadcast packet may often be a packet requiring response from a particular terminal. When a large number of broadcast packets reach terminals requiring responses therefrom, the loads for response processing are added, and more heavy load conditions are occurred.

As a result, there may be an increased possibility of a transmission processing delay of a response packet from the terminal of search object in response to the reachability confirmation packet, or suspension of the response packet, causing a possibility that the response packet cannot reach the network failure detection apparatus within a response packet reception time in the network failure detection apparatus. In other words, whereas there is no L2 loop occurred on the path to the terminal of search object, and there is reachability, the number of the response packets received in the network failure detection apparatus is decreased due to the heavy load, and when the reachability rate falls below the threshold, the network failure detection apparatus has a risk of incorrect detection of no reachability, i.e. incorrect detection of an L2 loop.

Therefore, according to the embodiment of the present invention, in order to avoid an inconvenient condition of inability of reachability confirmation affected by the heavy load, load reduction processor 14 performs processing for reducing the network load (load reduction processing).

The cause of the heavy loads in the respective terminals (including the terminal of search object and the network failure detection apparatus) due to the broadcast storm by the L2 loop is that the number of broadcast packets per unit time becomes so enormous as approaches the limit of the processing capacity of the respective terminals, or even exceeds the limit thereof. By decreasing the number of broadcast packets received per unit time, it becomes possible to reduce the load in each terminal.

For this purpose, load reduction processor 14 in network failure detection apparatus keeps on transmitting long packets, i.e. packets having a relatively long length, successively, as broadcast packet. In the network, broadcast packets including ARP, RIP and NetBIOS, are continuously transmitted, and accordingly the packets circulated in the L2 loop on the occurrence of the L2 loop are mostly the above packets. In particular, the ARP packet has a short packet length of the order of 64 bytes, and even the packets of NetBIOS have short packet lengths on the order of 200 bytes. On the occurrence of the L2 loop, the above short packets are broadcasted throughout the entire network area at the transmission line speed constituting the L2 loop. For example, when only ARP packets are circulating in an L2 loop of 100 Mbps, theoretically, there are 140 thousand packets per second of broadcast transmission which are transmitted from the L2 loop to the entire network area.

Load reduction processor 14 continuously transmits, for example, long packets of the order of 1,500 bytes. In the L2 loop, since packets of 1,500 bytes are input, as well as packets of the order of 64 bytes, and the packets are input continuously as well, an input queue or an output queue exceeds a tolerable value. Then, short packets having the length of approximately 64 bytes are discarded, and finally the entire packets having approximately 64 bytes are discarded. Thus, a state of only packets having 1,500 bytes circulated in the loop can be occurred. In the state of circulating only the packets of approximately 1,500 bytes, the number of packets of broadcast transmission from the L2 loop becomes 8,000 per second. As compared to the case of 64-byte packets, it becomes possible to reduce the number of received packets per unit time to approximately 1/20. As a result, the load in each terminal can be reduced, and the load condition can be restored to the degree capable of performing the reachability confirmation processing.

After performing the above-mentioned load reduction processing, the network failure detection apparatus transmits reachability confirmation packets to the terminal of search object, so as to perform the aforementioned reachability confirmation processing for deciding whether or not the L2 loop is existent.

Further, in order to perform the above-mentioned communication restoration processing and the load reduction processing simultaneously, broadcast packets (dummy packets) each having, as source address, a MAC address other than the MAC address of the terminal of search object, which is to be used for communication restoration processing, are transmitted continuously in a long packet form. By this, it becomes possible to perform the load reduction processing simultaneously.

The foregoing description of the embodiments is not intended to limit the invention to the particular details of the examples illustrated. Any suitable modification and equivalents may be resorted to the scope of the invention. All features and advantages of the invention which fall within the scope of the invention are covered by the appended claims.

What is claimed is:

1. A network failure detection apparatus, a first terminal among a plurality of terminals, detecting a failure in a network in which each terminal is connected to another terminal via at least one relay unit among a plurality of relay units, and comprising:
a transmission section transmitting a reachability confirmation data to a second terminal among the plurality of terminals;
a reception section receiving a response data from the second terminal in response to the reachability confirmation data; and
a decision section deciding whether a loop causing a predetermined network failure is occurred in a relay unit which is existent on the path to the second terminal, based on a receiving state of the response data.

2. The network failure detection apparatus according to claim 1,
wherein, based on the receiving state of the response data, the decision section decides whether or not there is reachability with the second terminal, and decides that the loop is occurred when deciding there is no reachability, and decides that the loop is not occurred when deciding there is reachability.

3. The network failure detection apparatus according to claim 2,
wherein the decision section obtains a reachability rate, which is a ratio of the number of the response data being received to the number of the reachability confirmation data being transmitted, and decides that there is no reachability when the reachability rate is lower than a predetermined value, and decides that there is reachability when the reachability rate is the predetermined value or higher.

4. The network failure detection apparatus according to claim 1,
wherein, when the number of the response data being received exceeds the number of the reachability confirmation data being transmitted, the decision step decides the loop is occurred.

5. The network failure detection apparatus according to claim 1, further comprising:
a communication restoration processor performing broadcast transmission of a plurality of data each having a source address excluding the second terminal address and the address of the network failure detection apparatus,
wherein the communication restoration processor performs broadcast transmission of the plurality of data before the transmission section transmits the reachability confirmation data to the second terminal.

6. The network failure detection apparatus according to claim 5, further comprising:
a monitoring section detecting reception of a broadcast data having, as source address, either the address of the network failure detection apparatus or the second terminal address, while the transmission section transmits the reachability confirmation data and the reception section receives the response data,
wherein, when the monitoring section detects reception of the broadcast data, the communication restoration processor performs broadcast transmission of the plurality of data again, and the transmission section transmits the reachability confirmation data, and the decision section decides whether or not the loop is occurred, based on the receiving state of the response data in the reception section.

7. The network failure detection apparatus according to claim 1, further comprising:
a load reduction processor performing broadcast transmission of a plurality of data having data lengths longer than the data length of the data circulating in the loop at the time of the occurrence of the loop,
wherein the load reduction processor performs broadcast transmission of the plurality of data before the transmission section transmits the reachability confirmation data to the second terminal.

8. The network failure detection apparatus according to claim 5,
wherein the plurality of data have longer data lengths than the data length of the data circulating in the loop at the time of the occurrence of the loop.

9. The network failure detection apparatus according to claim 1,
wherein the reachability confirmation data is an ARP data, which is transmitted to the second terminal in a unicast form.

10. The network failure detection apparatus according to claim 1,
wherein the reachability confirmation data is a Ping data, which is transmitted to the second terminal in a unicast form.

11. The network failure detection apparatus according to claim 1,
wherein the network failure is a layer 2 loop failure, in which the data circulating in the loop are continuously transmitted in a broadcast form from the loop.

12. A network failure detection method performed in a first terminal among a plurality of terminals, for detecting a failure in a network in which each terminal is connected to another terminal via at least one relay unit among a plurality of relay units, and comprising:
a transmission step for transmitting a reachability confirmation data to a second terminal among the plurality of terminals;
a reception step for receiving a response data from the second terminal in response to the reachability confirmation data; and
a decision step for deciding whether a loop causing a predetermined network failure is occurred in a relay unit which is existent on the path to the second terminal, based on a receiving state of the response data.

13. The network failure detection method according to claim 12,
wherein, based on the receiving state of the response data, the decision step decides whether or not there is reachability with the second terminal is existent, and decides that the loop is occurred when deciding there is no reachability, and decides that the loop is not occurred when deciding there is reachability.

14. The network failure detection method according to claim 13,
wherein the decision step obtains a reachability rate, which is a ratio of the number of the response data being received to the number of the reachability confirmation data being transmitted, and decides that there is no reachability when the reachability rate is lower than a predetermined value, and decides that there is reachability when the reachability rate is the predetermined value or higher.

15. The network failure detection method according to claim 12,
wherein, when the number of the response data being received exceeds the number of the reachability confirmation data being transmitted, the decision step decides the loop is occurred.

16. The network failure detection method according to claim 12, further comprising:
prior to the transmission step, a communication restoration step for performing broadcast transmission of a plurality of data each having a source address excluding the second terminal address and the address of the network failure detection apparatus.

17. The network failure detection method according to claim 16, further comprising:
during the reception step, a reception monitoring step for detecting reception of a broadcast data having, as source address, either the address of the network failure detection apparatus or the second terminal address, and when the reception monitoring step detects reception of the broadcast data, the transmission step, the reception step and the decision step are repeated again.

18. The network failure detection method according to claim 12, further comprising:
prior to the transmission step, a load reduction step for performing broadcast transmission of a plurality of data having data lengths longer than the data length of the data circulating in the loop at the time of the occurrence of the loop.

19. The network failure detection method according to claim 16,
wherein the plurality of data have data lengths longer than the data length of the data circulating in the loop at the time of the occurrence of the loop.

20. The network failure detection method according to claim 12,
wherein the network failure is a layer 2 loop failure, in which the data circulating in the loop are continuously transmitted in a broadcast form from the loop.
